(19) United States
(12) Patent Application Publication
(10) Pub. No.: US 2005/0184167 A1
(43) Pub. Date: Aug. 25, 2005

(54) Heating, ventilating, and air-conditioning system utilizing a pressurized liquid and a fluid-turbine generator

(76) Inventors: Stanley Bach, Stuart, FL (US); William J. Mathers, Stuart, FL (US); Robert S. Zelko, Stuart, FL (US)

Correspondence Address: Loren Donald Pearson, P.A., P.O. Box 402571, Miami Beach, FL, 33140-2571, US

(21) Appl. No.: 11/065,585

(22) Filed: Feb. 24, 2005

Related U.S. Application Data
(60) Provisional application No. 60/547,100, filed on Feb. 24, 2004.

(51) Int. Cl. B60H 1/02; F28F 7/00; F24D 1/04; F24D 5/00

(52) U.S. Cl. 237/12.1

(57) ABSTRACT

A heating, ventilating, and air-conditioning system utilizes a pressurized fluid to generate heat and drive the components of the system. As the pressurized fluids turns the components heat is generated. The heat in the fluid can be transferred to air via a heat exchanger and/or a radiant heater. A generator is turned by the pressurized fluid and generates electricity for an auxiliary fluid heater and operation of the system and/or backfed to a battery or power grid.

### CROSS-REFERENCE TO RELATED APPLICATION

This application claims the benefit of U.S. Provisional Application No. 60/547,100, filed Feb. 24, 2004.

### BACKGROUND OF THE INVENTION

1. Field of the Invention

The present invention relates to heating, ventilating, and air conditioning (HVAC) systems that utilize a pressurized fluid for generating heat, air conditioning, and electric current.

2. Description of the Related Art

Many applications require the generation and transferring of heat. Examples that require the generation of heat to warm a fluid medium (i.e. water or air) include systems for heating buildings, clothes dryers, and water heating units. Such known configurations utilize various heat sources. Known heat sources include electrical resistance elements and oil, natural-gas, coal, and other burners.

Electrical resistance elements are inexpensive, develop high temperatures in short time periods, and can be readily supplied with electrical operating power. However, such resistance elements have high power consumption rates and are therefore costly to operate compared to other available heating systems. Oil and gas burner units can be more cost effective to operate than electrical resistance based units, but oil and gas burner units also have their drawbacks such as limitations based on availability of the respective combustible fluids in particular localities, the potential for operating cost fluctuations based on various global factors and the bulkiness of the overall units.

The above problems show that each of the commonly known heating configurations has its associated advantages and disadvantages. In general, operational efficiencies must be compromised if operational costs are to be minimized. Furthermore, the overall compactness of prior-art units represents a significant limitation.

U.S. Pat. No. 5,979,435 proposes a solution using a heated liquid medium. The heated liquid medium is pressurized, released, and heated through friction. The heated fluid is used to donate heat to other systems.

If hydraulic fluid is used in a system like the one proposed in U.S. Pat. No. 5,979,435, many limitations become obvious. While the patent teaches using water and air as fluids, hydraulic fluid is required for reasons of heat capacity and pressurization. To create a heat transfer equaling conventional heaters, a system utilizing hydraulic fluid requires pressures above 17.25 mPA (2500 psi) and temperatures above 140° C. However, at these temperatures and pressures, hydraulic fluid breaks down. Furthermore, when heated by the frictional heaters, the hydraulic fluid foams. In addition, the pumps needed to create the pressure cause cavitation, which adds gas to the fluid. When gas bubbles exist in the plumbing, hammering and knocking occurs. When the gas is vented from the hydraulic fluid, the fumes are noxious. Finally, hydraulic fluid is toxic and poses risk whenever applied near people, especially, in homes.

Experiments have shown that a system taught by U.S. Pat. No. 5,979,435 run with hydraulic fluid at a temperature below 140° C. to avoid break down only allowed 0.189 m³/s (400 ft³/min) of air to be heated. This amount of heat exchange is not sufficient for most household applications.

Therefore, there exists a need for a heating system that uses a liquid medium for heat that supplies sufficient heat within traditionally sized systems to replace traditional systems and that does not produce noxious fumes and risks of toxic spills.

### SUMMARY OF THE INVENTION

An object of the invention is to develop an all-electrical based (i.e. non fossil fuel burning) heating system with a low operating cost. The system will take in cold, fresh, moist air and heat it to a comfortable room temperature without significantly removing the moisture from the air. This system not only makes heat, but also provides energy for additional tasks. The system raises the fluid temperature to compensate for increases in work output. The heating system receives cold air at very low temperatures with the capacity to raise the indoor temperature to 80° C. or higher. This will allow for greater fresh air intake and stale air venting.

A generator is also a component of this system. The generator provides electricity that can be used by an auxiliary heater. The generator is powered by a turbine that is turned by the pressurized fluid. The electricity created by the generator also can power the power controller (i.e. CPU), the electric-powered valves, and the drive pump. Unused power can be stored in batteries or fed to the power grid. By recapturing some of the power input, the generator directly reduces the primary electrical power required to run the heating system, as well as mechanically heat the fluid.

The system operates at lower pressures than normally used in hydraulic systems. The system has an electric motor that drives a fluid pump. This pump pressurizes the system and provides flow for a fluid motor that turns a gearbox that provides the proper RPM for the generator. The fluid then flows to a second fluid motor that mechanically turns the blower. The blower draws air through an air filter, through a heat exchange unit, and forces it through the duct system into areas to be heated. If the required fluid temperature drops below a minimum, an auxiliary electrical heater element brings the fluid to the required temperatures as controlled by a thermostat. Next, the fluid flows through the heated air exchange unit to a ported valve system that will allow the warm fluid to continue the heating process by an optional or primary radiant heating system. The fluid then flows back to the reservoir and the initial fluid drive pump to repeat the next cycle.

In accordance with the objects of the invention, a heating system is provided. The heating system includes a fluid, tubing, a drive pump, a generator, and an air handler. The fluid is pressurized by the drive pump and circulated through the tubing. The generator creates electricity and is connected to the tubing downstream of the drive pump. The pressurized fluid turns the generator and thereby heats the pressurized fluid. The air handler is connected to the tubing downstream of the generator and has a heat exchanger and a fan. The heat exchanger is heated by the fluid. The fan is turned by the fluid and thereby heats the fluid and blowing air to be heated through the heat exchanger.

The fluid is a proprietary fluid. For use in cold locations, the fluid should have a pouring temperature no greater than −43° C. To guarantee that the fluid continues to work even in abnormally high, yet foreseeable, temperatures, the fluid should have a boiling point greater than 316° C. To provide quiet operation and prevent formation of noxious fumes, the fluid should not foam or cavitate under operating conditions. Specifically, the fluid should not foam and cavitate at a temperature below 60° C. and a pressure below 3.45 mPa.

A further object of the invention is to provide a heating system that has enough heat capacity to heat at least 0.236 m³/s, and more preferably at least 0.473 m³/s, of air to at least 30° C. above an intake temperature.

It is a further object of the invention to provide a heater that heats air immediately upon startup. To prevent a lag between drive-pump startup and heat, an electrical heater can be disposed in the heat exchanger. The heat exchanger heats the fluid to a set temperature, preferably at least 37.8° C. The electrical heater can also be used to supplement the heat of the fluid during sustained operation that requires extra amounts of heat capacity. A further object of the invention is to provide an electrical heater that heats the fluid to at least 43.3° C. When the fluid is heated to 43.3° C., for most airflows, the air is heated to at least 40.6° C.

In accordance with a further object of the invention, electricity generated by the generator can be used to power the electrical heater. Alternatively, the electrical heater can be fed by a primary source such as a battery or power grid.

In accordance with a further object of the invention, a radiant heater can be connected to the tubing downstream of the air handler. The radiant heater would include a radiator that allows heat to be radiated from the fluid. The radiant heater can be buried in the flooring or walls.

Other features which are considered as characteristic for the invention are set forth in the appended claims.

Although the invention is illustrated and described herein as embodied in a pressurized liquid and a fluid-turbine generator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWINGS

The FIGURE is a partial schematic and partial diagrammatic view of the system according to the invention.

### DETAILED DESCRIPTION OF THE PREFERRED EMBODIMENT

Referring now to the single FIGURE of the drawing, it is seen that a heating system has a (non-electrical) circuit formed by a power pack, which is connected to an air handler, which is connected to a radiant heat module, which is connected to the power back.

The sole FIGURE of the application shows a preferred embodiment for a heating and cooling system. Generally, except where specified below, the heating and cooling system is formed by a closed (i.e. recycling) circuit of piping that carries a fluid. The heating and cooling system includes several subsystems: a power pack 100, an air-conditioner cycle 200, an air handler 300, and radiant heater 400.

The power pack 100 includes a fluid tank 101. The fluid tank 101 acts as a reservoir for collecting fluid, holding extra fluid, and providing fluid as needed. In addition, the fluid tank 101 allows a space for expansion of the fluid upon return. The fluid tank 101 has a fluid tank outlet 102. The fluid tank outlet 102 is connected to a first drive pump 103. The first drive pump 103 pressurizes the fluid through the system. Pressures between 2.07 Mpa and 3.45 Mpa (i.e. 300-500 psi) are generated by the first drive pump 103. The first drive pump 103 is powered by a motor 104. The motor 104 is preferably an electrical motor. In particular, an axial field motor like the one taught in U.S. Pat. No. 5,982,074 is used. The horsepower of the drive pump 103 and motor can be tailored to the application. For applications, requiring greater heat exchange, a larger horsepower motor 104 is used.

The accelerated fluid reaches a generator junction 105 in the piping. The accelerated fluid can be passed through a generator 106 and/or a bypass valve 107. The bypass valve 107 diverts flow from the generator 106 when open. When the bypass valve 107 is closed, the fluid turns a generator turbine 108. The generator turbine 108 is mechanically coupled to a gearbox 109. Preferably, the gearbox 109 is a speed doubler. The gearbox 109 turns the generator 106. The generator 106 produces electrical current as it is turned. The generator 106 is preferably an axial field generator, like those described in U.S. Pat. No. 5,982,074, which is incorporated by reference. In alternative embodiments, the generator can be an alternator or other means for converting mechanical energy to electrical energy. The generator 106 is connected to a power controller 110. The fluid leaves the generator and/or bypass valve at the generator junction 111.

The generator 106 restricts flow through the generator turbine 108 and creates friction, which increases the fluid temperature in the system. This heating reduces the dependence on an ancillary heater (i.e. heater 307). When used, the generator 106 and the output power controller 110 direct power as required to optimize and reduce the demand on the incoming primary power. The power controller 110 can open and close the bypass valve 107 to throttle the generator 106.

The power controller 110 controls the generator fluid bypass valve 107 to adjust the speed of the generator 106 as required and buffer system on/off cycles. The power controller 110 thereby optimizes the output power of the generator 106 and reduces the required primary power.

From the generator junction 111, the fluid flows to the air-conditioner split 201. An air-conditioner control valve 202 controls the flow of fluid that reaches a chiller 204. An air-conditioner bypass valve 203 diverts flow from the chiller 204 when the air-conditioner 200 is not operating. An air-conditioner check valve 205 prevents fluid from flowing backward into the chiller 204. The fluid flowing from the chiller 204 and/or the air-conditioner bypass valve 203 joins at the air-conditioner junction 206.

Although not detailed, the air conditioner involves a typical air conditioner system with a refrigerant compressor, a blower, and an evaporator/heat exchanger. The coolant system is separate from the pressure fluid system. The compressor motor and air-conditioner blower are powered by the pressurized fluid. In a further possible embodiment, refrigerant for the air-conditioner is the same fluid that is pressurized and used throughout the system.

From the air-conditioner junction 206, the fluid reaches the air handler 300 at the air-handler split 301. A third drive pump 302 is downstream of the air-handler spit 301. A bypass valve 303 allows diversion of fluid from the third drive pump 302.

The air handler 300 includes a cabinet 304. The cabinet 304 is sized to comply with standard sized air handlers. Within the cabinet 304, a blower assembly 305 is disposed. The blower assembly 305 includes a fan 306, which is preferably a drum fan. The fan 306 is connected to a fan turbine 302. The fan turbine 302 is turned by the pressurized fluid. As it spins, the fan turbine 302 turns the fan 306. As the fan turbine 302 spins the fluid becomes further heated. The fan 306 pushes air through the heat exchanger 308. An electrical heater 307 heats the fluid if necessary; typically the electrical heater 307 is necessary if extremely low temperatures exist or when the electric motor has not been active for a long time. The heat exchanger 308 heats the air pushed by the fan 306. The fluid pressure drops significantly after passing through the heat exchanger 308. An air filter 309 filters the heated air following the heat exchanger 308. The heated air passes through a plenum, which is not shown, and can be distributed throughout a building by air ducts, which are also not shown.

The heat exchanger 308 is preferably a multi-staged unit. The fluid flow is controlled so a maximum heat exchange can take place between the fluid and air flow. The moisture level in the incoming air flow is maintained and will not be sufficiently altered by the heating system. However, if moisture control is required, a humidifier can be added to the air handler 300.

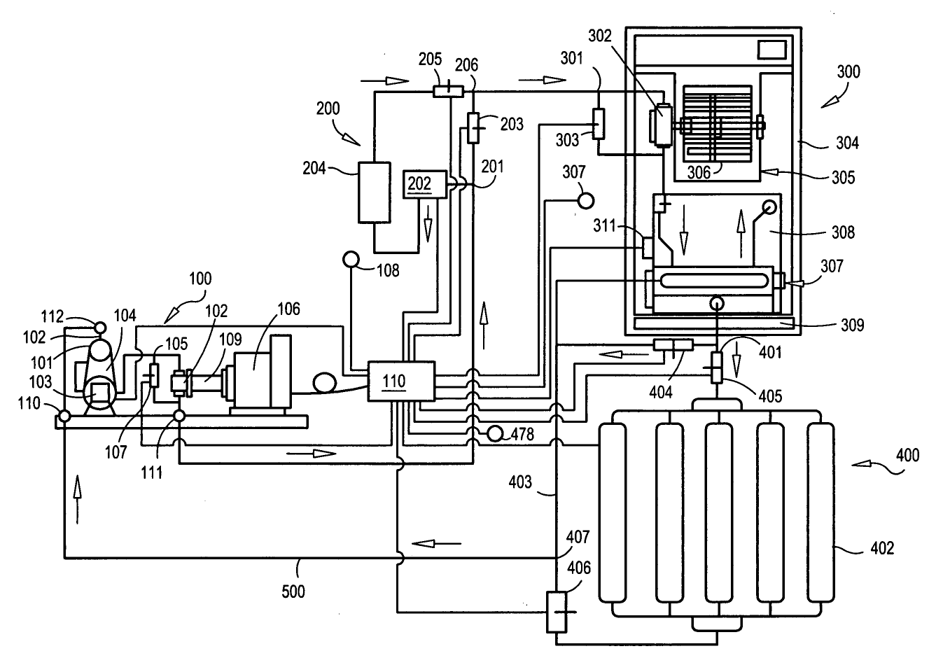

Although FIG. 1 shows one heat exchanger, more heat exchangers can be included to increase the heat transfer.

In addition, multiple air handlers 300 can be connected in parallel or series with each other. By having more than one air handler 300, more zones can be heated. Furthermore, each air handler can have a respective thermostat 307 controlling it.

Multiple thermostats 307 allow for zones within to be heated to different temperatures.

After the air handler 300, the fluid reaches the radiant heater 400. The radiant heater 400 has a radiant heater split 401. At the radiant heater split 401, the fluid can be diverted between the radiator 402 and the radiant heater bypass 403. A radiant-heater bypass valve 404 controls the flow through the radiant-heater bypass 403. When the radiant-heater bypass valve 404 is open, the fluid flows through the radiant-heater bypass 403. When the radiant-heater bypass valve 404 is closed, the fluid cannot flow through the bypass 403. Similarly, a radiator valve 405 controls flow of the fluid through the radiator 402. The radiator 402 is formed by at least one pipe; when more than one pipe is used, the pipes are typically disposed parallel to each other. For radiant floor heating, the radiator 402 is disposed within the flooring, foundation, or wall of the room to be heated. A radiator check valve 406 is placed downstream from the radiator 402 and prevents the fluid from flowing backward into the radiator 402. The radiator bypass 403 joins fluid from the radiator 402 at the radiant-heater junction 407.

From the radiant heater 400, the fluid returns to an inlet 110 of the fluid tank 101 of the power pack 100. The fluid collects in the fluid tank 101. A fluid filter 112 interconnects the return 500 and the fluid tank 101. The fluid filter 112 strains particles in the fluid and separates them from the fluid entering the fluid tank 101.

Steel hydraulic piping is used to connect the power pack 100 to the air-conditioner 200 and to the air handler 300. Pressures after the air handler 300 are significantly less 0.069 Mpa to 0.10 Mpa (10 to 15 psi) are typical. The radiant heater 400 and the return 500 can be manufactured from standard copper plumbing because the fluid has significantly less pressure.

The preferable fluid is a fluid sold under the trade name HCL-3. The fluid is preferably a proprietary high-viscosity, biodegradable, non-toxic, non-hazardous, synthetic hydraulic and heat transfer fluid. The fluid is made with the thermally and oxidatively stabile non-toxic and non-hazardous base fluids. The combined fluid is further enhanced with additives that extend the fluid life and thermal performance over other competitive synthetic fluids. Proprietary chemistry for this product also provides for even higher operating temperatures, in both open and closed systems. The fluid is approved by the USDA for H-1 applications and fully complies with the requirements of the FDA Rule § 178.3570 (21 CFR 178.3570). This is a biodegradable fluid, which is non-toxic and non-hazardous, and does not form carbon in most specifications. The properties of the fluid are Viscosity cSt @ 316° C. (600° F.) using Test Method D-445. The fluid has a pour point −43° C. (−45° F.)

The power controller 110 preferably includes a central processing unit that evaluates and controls the various functions of the system.

For example, thermostats 207, 310, and 408 are connected by wiring to the power controller 110. When the thermostat 207 detects a temperature above a set temperature, the power controller opens the air-conditioner control valve 202 and closes the air-conditioner bypass valve 203. In addition, the power controller 110 activates the electric motor 104 to pressurize the fluid. When the thermostat 207 detects that the room temperature has reached the set point, the power controller closes the air-conditioner control valve 202 and opens the air-conditioner bypass valve 203. If no other system requires pressurized fluid, the power controller 110 deactivates the electric motor 104.

If the thermostat 307 detects a room temperature below a set point, the power controller 110 activates the air handler 300.

The power controller 110 activates the air handler 300 by powering the electric motor 104 to pressurize the fluid. The power controller 110 closes the air-handler bypass valve 303. The temperature of the fluid at the heat exchanger 308 is measured by the thermocouple 311. If the fluid temperature at the thermocouple is too low, the electric heater 307 is activated by the power controller. The power controller 110 closes the bypass valve 107 to divert fluid through the generator 106; the generator 106 provides the electrical power for the electric heater 307. When the thermostat 307 detects that the room temperature has reached the set point, the power controller opens the air handler bypass 303 and deactivates the heater 307 if the heater 307 is on. If no other system requires pressurized fluid, the power controller 110 deactivates the electric motor 104.

The power controller 110 activates the radiant heater 400 when the thermostat 408 reads a room temperature below a set point. The power controller 110 activates the electric motor 104 to pressurize the fluid. After the fluid passes the generator 106 and the heat exchanger 308, the fluid will have gained enough heat to work as a medium for radiating heat. The power controller 110 opens the radiator valve 405 and closes the radiant-heater bypass valve 404 to allow the heated fluid to flow through the radiator 402. When the room temperature reaches the set point, the power controller 110 closes the radiator valve 405 and opens the radiant-heater bypass valve 404. If no other system requires pressurized fluid, the power controller 110 deactivates the electric motor 104.

1. A heating system, comprising:
a fluid;
tubing holding said fluid;
a drive pump connected to said tubing for pressurizing said fluid;
a generator for creating electricity connected to said tubing downstream of said drive pump and turned by said pressurized fluid and thereby heating said pressurized fluid; and
an air handler connected to said tubing downstream of said generator and having a heat exchanger and a fan, said heat exchanger being heated by said fluid, said fan being turned by said fluid and thereby heating said fluid and blowing air to be heated through said heat exchanger.

2. The heating system according to claim 1, wherein said fluid:
has a pouring temperature no greater than −43° C.;
has a boiling point greater than 316° C.;
does not foam and cavitate at a temperature below 60° C. and a pressure below 3.45 mPa.

3. The heating system according to claim 1, wherein said fan blows at least 0.236 m³/s of the air through said heat exchanger and said heat exchanger heats the air to at least 30° C. above an intake temperature.

4. The heating system according to claim 3, wherein said fan blows at least 0.473 m³/s of the air through said heat exchanger and said heat exchanger heats the air to at least 30° C. above the intake temperature.

5. The heating system according to claim 1, further comprising an electrical heater disposed in said heat exchanger for heating said fluid to at least 37.8° C.

6. The heating system according to claim 5, wherein said electrical heater heats said fluid to at least 43.3° C.

7. The heating system according to claim 5, wherein said electrical heater heats said fluid to a temperature that heats the air to at least 40.6° C.

8. The heating system according to claim 5, wherein said electrical heater is powered by said generator.

9. The heating system according to claim 5, wherein said electrical heater is powered by a primary source.

10. The heating system according to claim 5, wherein said heater heats said fluid before said heater is heated by said generator and said fan.

11. The heating system according to claim 1, further comprising a radiant heater connected to said tubing downstream of said air handler and having a radiator, said radiator releasing heat from said fluid.

12. The heating system according to claim 1, wherein said tubing forms a closed circuit.

13. The heating system according to claim 6, further comprising a reservoir connected to said tubing upstream of said pump and downstream of said air handler for collecting said fluid, holding said fluid, and supplying said fluid to said pump.

14. The heating system according to claim 1, wherein said drive pump is immersed in said fluid.
